(19) United States
(12) Patent Application Publication
(10) Pub. No.: US 2015/0241337 A1
(43) Pub. Date: Aug. 27, 2015

(54) METHODS OF USING AN ANALYZER TO COMPLY WITH AGENCY REGULATIONS AND DETERMINE ECONOMIC VALUE

(71) Applicant: HALLIBURTON ENERGY ERVICES, INC., Houston, TX (US)

(72) Inventors: Reza Talabi, The Woodlands, TX (US); Cyrus A. Irani, Houston, TX (US)

(21) Appl. No.: 14/420,492

(22) PCT Filed: Oct. 26, 2012
(86) PCT No.: PCT/US12/62062

§ 371 Date: Feb. 9, 2015

(51) Int. Cl. G01N 21/25; G06Q 30/00; G06Q 30/02; E21B 49/08; G01V 8/10

(52) U.S. Cl. CPC G01N 21/255; E21B 49/088; G01V 8/10; G06Q 30/0278; G06Q 30/018; G01N 2201/06113; G01N 2201/12

(57) ABSTRACT

A method of complying with a regulatory agency's requirement comprises: determining a minimum number of properties of a reservoir fluid using an analyzer, wherein the minimum number of properties is sufficient to comply with the regulatory agency's requirement, and wherein the step of determining comprises: (A) contacting the reservoir fluid with radiated energy; and (B) detecting the interaction between the radiated energy and the reservoir fluid. A method of determining the economic value of a produced reservoir fluid comprises: (A) producing the reservoir fluid; (B) determining at least one property of the reservoir fluid using the analyzer; (C) determining the flow rate of the reservoir fluid, wherein the step of determining the flow rate is performed during the step of producing; and (D) calculating the economic value of the produced reservoir fluid using the at least one property and the flow rate of the reservoir fluid.

### TECHNICAL FIELD

A method of complying with a regulatory agency's requirement is provided. A method of determining the economic value of a produced reservoir fluid is also provided. The methods include determining at least one property of the reservoir fluid using an analyzer. The methods can also include determining the flow rate of the reservoir fluid. The properties of the reservoir fluid and also the flow rate can then be used to comply with requirements for reporting to state agencies and requirements for storage and transportation containers. The properties can be compositional components of the reservoir fluid. The components, the percentage of each component, the market value of each component, and the flow rate of the reservoir fluid can all be used to calculate the economic value of the produced fluid at a specific moment in the production of the fluid.

### SUMMARY

According to an embodiment, a method of complying with a regulatory agency's requirement comprises: determining a minimum number of properties of a reservoir fluid using an analyzer, wherein the minimum number of properties is sufficient to comply with the regulatory agency's requirement, and wherein the step of determining comprises: (A) contacting the reservoir fluid with radiated energy; and (B) detecting the interaction between the radiated energy and the reservoir fluid.

According to another embodiment, a method of determining the economic value of a produced reservoir fluid comprises: (A) producing the reservoir fluid; (B) determining at least one property of the reservoir fluid using an analyzer, wherein the step of determining comprises: (i) contacting the reservoir fluid with radiated energy; and (ii) detecting the interaction between the radiated energy and the reservoir fluid; (C) determining the flow rate of the reservoir fluid, wherein the step of determining the flow rate is performed during the step of producing; and (D) calculating the economic value of the produced reservoir fluid using the at least one property and the flow rate of the reservoir fluid.

### BRIEF DESCRIPTION OF THE FIGURES

The features and advantages of certain embodiments will be more readily appreciated when considered in conjunction with the accompanying figures. The figures are not to be construed as limiting any of the preferred embodiments.

FIG. 1 is a diagram of a reservoir fluid container including a reservoir fluid receptacle.

FIG. 2 is a diagram of an analyzer for analyzing one or more properties of a reservoir fluid.

FIG. 3 is a diagram of the analyzer from FIG. 2 according to an embodiment depicting analysis of the reservoir fluid during collection of the reservoir fluid.

FIG. 4 is a diagram of the analyzer from FIG. 2 according to another embodiment depicting analysis of the reservoir fluid during transference of the reservoir fluid.

FIG. 5 is a diagram of a well system containing the analyzer and a flow meter.

### DETAILED DESCRIPTION

As used herein, the words “comprise,” “have,” “include,” and all grammatical variations thereof are each intended to have an open, non-limiting meaning that does not exclude additional elements or steps.

It should be understood that, as used herein, “first,” “second,” “third,” etc., are arbitrarily assigned and are merely intended to differentiate between two or more analyzers, heating elements, etc., as the case may be, and does not indicate any sequence. Furthermore, it is to be understood that the mere use of the term “first” does not require that there be any “second,” and the mere use of the term “second” does not require that there be any “third,” etc.

As used herein, a “fluid” is a substance having a continuous phase that tends to flow and to conform to the outline of its container when the substance is tested at a temperature of 71° F. (22° C.) and a pressure of one atmosphere “atm” (0.1 megapascals “MPa”). A fluid can be a liquid or gas. A fluid can have only one phase or more than one phase. In the oil and gas industry, a fluid having only one phase is commonly referred to as a single-phase fluid and a fluid having more than one phase is commonly referred to as a multi-phase fluid. A colloid is an example of a multi-phase fluid. A colloid can be: a slurry, which includes a continuous liquid phase and undissolved solid particles as the dispersed phase; an emulsion, which includes a continuous liquid phase and at least one dispersed phase of immiscible liquid droplets; a foam, which includes a continuous liquid phase and a gas as the dispersed phase; or a mist, which includes a continuous gas phase and liquid droplets as the dispersed phase.

Oil and gas hydrocarbons are naturally occurring in some subterranean formations. A subterranean formation containing oil or gas is sometimes referred to as a reservoir. A reservoir may be located under land or off shore. Reservoirs are typically located in the range of a few hundred feet (shallow reservoirs) to a few tens of thousands of feet (ultra-deep reservoirs). In order to produce oil or gas, a wellbore is drilled into a reservoir or adjacent to a reservoir.

A well can include, without limitation, an oil, gas, or water production well, or an injection well. As used herein, a “well” includes at least one wellbore. A wellbore can include vertical, inclined, and horizontal portions, and it can be straight, curved, or branched. A portion of a wellbore may be an open hole or cased hole. In an open-hole wellbore portion, a tubing string may be placed into the wellbore. The tubing string allows fluids to be introduced into or flowed from a remote portion of the wellbore. In a cased-hole wellbore portion, a casing is placed into the wellbore that can also contain a tubing string. As used herein, the term “wellbore” includes any cased, and any uncased, open-hole portion of the wellbore. A reservoir fluid can be produced by allowing or flowing the fluid up through a tubing string to the wellhead. The produced fluid can then be collected, transported, stored, or refined.

There are a multitude of regulatory agencies that require a reservoir fluid to be analyzed. The analysis of a reservoir fluid generally involves determining several properties of the fluid and possibly the rate of production of the fluid. Some of the properties of a fluid can also be used to calculate other properties of the fluid and report both, the determined and calculated properties to a given regulatory agency.

One example of a regulatory agency that requires reporting of reservoir fluid properties is a state agency that oversees drilling and production of reservoir fluids. For example, in Texas, the Railroad Commission (RRC) requires reporting forms to be completed and submitted at a variety of frequencies (e.g., monthly, annually, prior to drilling, during production, etc.). The Texas RRC's Form G-5 entitled “Gas Well Classification Report,” for example, requires the gas volume, oil or condensate volume, water volume, and gas to liquid hydrocarbon ratio (commonly called the gas-to-oil ratio “GOR”), among other data, to be completed and submitted for each well. The Texas RRC's Form G-1 entitled “Gas Well Back Pressure Test, Completion or Recompletion Report, and Log,” also requires the gravity of dry gas and liquid hydrocarbon, as well as the GOR and other data to be completed for each well. Moreover, other states, such as Oklahoma via its regulatory agency, the Oklahoma Corporation Commission, require some or all of the same data that Texas requires to be reported to its state agency. Some state regulatory agencies may also require the production rate of a reservoir fluid to be reported on its forms (sometimes expressed in units of thousand cubic feet per day “MCF/day” for gas or barrels per day “bbl/day” for oil).

Another example of a regulatory agency that requires the properties of a reservoir fluid to be determined are governmental agencies that regulate the storage and/or transportation of certain substances. An example of an agency in the United States that regulates storage and/or transportation of substances is the Department of Transportation (“DOT”). Examples of classes of substances that are currently regulated by the DOT include, but are not limited to: explosives; flammable materials; corrosive materials; certain gases; radioactive materials; and hazardous materials, such as infectious materials and pressurized materials. Each class can include several unique substances. It is common for such regulatory agencies to impose requirements for the containers that regulated substances are to be stored or transported in. Therefore, it is common to analyze a reservoir fluid to determine its properties prior to storage and/or transportation in order to comply with the container requirements of an agency.

During production of a reservoir fluid, it is also desirable to determine the properties of the fluid and the production rate in order to calculate the economic value of the fluid at that point in production. For example, if the properties and production rate of the fluid can be determined, then the total currency generated per unit of time can be calculated based on the current market price of the exact fluid being produced and the production rate. Being able to determine the properties and production rate at the well site, means that informed decisions concerning sales or the desired amount of production can be made in a quicker and more efficient manner compared to having to send a sample of the fluid off-site for analysis.

There are a variety of instruments that can be used to collect a sample of reservoir fluids. One such instrument is the ARMADA® sampling system, marketed by Halliburton Energy Services, Inc. In order to collect a reservoir fluid, the sampling system is placed into a wellbore at a desired location. The sampling system functions to collect multiple samples of the reservoir fluid at that location. The ARMADA® sampling system is currently able to collect up to nine unique samples of the reservoir fluid per trip. The sampling system is then returned to the surface where the samples can be retrieved from the system.

In order to determine one or more properties of a reservoir fluid, a collected sample is generally sent to an off-site laboratory for analysis. It can be quite costly to analyze each collected sample. Furthermore, the sampling containers, storage containers, and shipping containers may not be compliant with a country's transportation regulations because the exact composition of the fluid is unknown prior to sending the samples off-site.

After being sent to an off-site laboratory, the samples are then analyzed. There are several devices that can be used to analyze the fluid. Some devices are designed to be used in a laboratory setting and other devices can be used in a well or at or near the well site. A spectrometer is an example of a device that can be used to analyze a fluid. Spectroscopy is the study of the interaction between matter and radiated energy. Generally, an energy source, such as light, is directed onto and possibly through a reservoir fluid. A detector can then detect the light emitted from the source after the light passes through the reservoir fluid. One of the central concepts in spectroscopy is a resonance and its corresponding resonant frequency. Spectroscopic data is often represented by a spectrum, a plot of the response of interest as a function of wavelength or frequency. A plot of amplitude versus excitation frequency will have a peak centered at the resonance frequency. This plot is one type of spectrum, with the peak often referred to as a spectral line, and most spectral lines have a similar appearance.

Spectroscopy can be classified based on the type of the radiative energy source, the nature of the interaction, or the type of material of the reservoir fluid. The types of radiative energy can include electromagnetic radiation, particles, acoustic, and mechanical. Techniques that employ electromagnetic radiation are typically classified by the wavelength region of the spectrum and include microwave, terahertz, far infrared, infrared, near infrared, visible, ultraviolet, x-ray and gamma spectroscopy. A wavelength is the distance over which a wave repeats itself, is inversely proportional to the frequency, and is reported in units of length (e.g., micrometers, nanometers, or meters). The higher the frequency the shorter the wavelength and the lower the frequency the longer the wavelength. The frequency is the number of occurrences per unit of time, reported in units of seconds. A wavenumber is proportional to the reciprocal of the wavelength, reported in units of inverse meters (m⁻¹) or inverse centimeters (cm⁻¹). The wavelength regions for each type of electromagnetic radiation are different. For example, the near infrared region has a wavelength of approximately 800 nanometers (nm) to 2500 nm; whereas, the ultraviolet region has a wavelength of approximately 10 nm to 400 nm. Uncharged and charged particles, due to their de Broglie wavelength, can also be a source of radiative energy and electrons, protons, and neutrons are commonly used. For a particle, its kinetic energy determines its wavelength. Acoustic spectroscopy involves the use of radiated pressure waves, while mechanical methods can be employed to impart radiating energy, similar to acoustic waves, to solid materials.

Types of spectroscopy can also be distinguished by the nature of the interaction between the energy and the material. These interactions include absorption, emission, elastic scattering and reflection, impedance, inelastic scattering, and coherent interactions. Absorption occurs when energy from the radiative source is absorbed by the material. Absorption is often determined by measuring the fraction of energy transmitted through the material, wherein absorption will decrease the transmitted portion. Emission indicates that radiative energy is released by the material. A material's blackbody spectrum is a spontaneous emission spectrum determined by its temperature. Emission can be induced by electromagnetic radiation in the case of fluorescence. Elastic scattering and reflection spectroscopy determine how incident radiation is reflected or scattered by a material. Impedance spectroscopy studies the ability of a medium to impede or slow the transmittance of energy. Inelastic scattering involves an exchange of energy between the radiation and the matter that shifts the wavelength of the scattered radiation. These include Raman and Compton scattering. Coherent or resonance spectroscopy are techniques where the radiative energy couples two quantum states of the material in a coherent interaction that is sustained by the radiating field. The coherence can be disrupted by other interactions, such as particle collisions and energy transfer, and thus, often require high intensity radiation to be sustained. Nuclear magnetic resonance (NMR) spectroscopy is a widely used resonance method and ultrafast laser methods are also now possible in the infrared and visible spectral regions.

There is a need for being able to analyze one or more properties of a reservoir fluid at the well site and also determine the production rate of the fluid in order to more quickly and easily comply with a specific regulatory agency's requirements or determine the economic value of the fluid being produced. By being able to analyze a reservoir fluid prior to shipment to an off-site laboratory, means that forms required by regulatory agencies can be completed and submitted more quickly and less expensively, the proper storage or transportation containers can be selected based on the composition of the fluid, and the economic value of the produced fluid can be determined much quicker.

It has been discovered that an analyzer and optionally, a flow meter, can be used at a well site in order to comply with regulatory agency's requirements and to determine the economic value of a fluid.

According to an embodiment, a method of complying with a regulatory agency's requirement comprises: determining a minimum number of properties of a reservoir fluid using an analyzer, wherein the minimum number of properties is sufficient to comply with the regulatory agency's requirement, and wherein the step of determining comprises: (A) contacting the reservoir fluid with radiated energy; and (B) detecting the interaction between the radiated energy and the reservoir fluid.

According to another embodiment, a method of determining the economic value of a produced reservoir fluid comprises: (A) producing the reservoir fluid; (B) determining at least one property of the reservoir fluid using an analyzer, wherein the step of determining comprises: (i) contacting the reservoir fluid with radiated energy; and (ii) detecting the interaction between the radiated energy and the reservoir fluid; (C) determining the flow rate of the reservoir fluid, wherein the step of determining the flow rate is performed during the step of producing; and (D) calculating the economic value of the produced reservoir fluid using the at least one property and the flow rate of the reservoir fluid.

Any discussion of the embodiments regarding the analysis of the reservoir fluid is intended to apply to all of the method embodiments. Any discussion of a particular component of an embodiment (e.g., an analyzer) is meant to include the singular form of the component and also the plural form of the component, without the need to continually refer to the component in both the singular and plural form throughout. For example, if a discussion involves “the analyzer 20,” it is to be understood that the discussion pertains to one analyzer (singular) and two or more analyzers (plural).

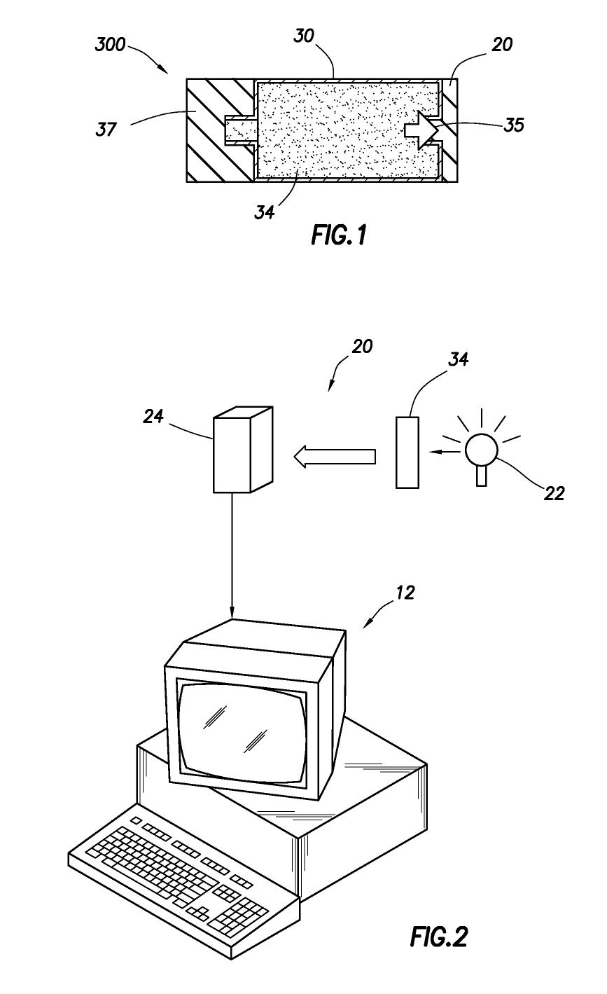

Turning to the Figures. FIG. 1 depicts a sample container 300 according to an embodiment. The methods can further include the step of collecting a sample of the reservoir fluid in the sample container 300. According to an embodiment, the sample container 300 is part of the ARMADA® sampling system, marketed by Halliburton Energy Services, Inc. The sample container 300 can include a sample receptacle 30. The sample receptacle 30 can have two ends; a first end and a second end. The sample receptacle 30 can include a first opening. The sample receptacle 30 can also include a second opening. The openings can be located at the first and second ends. The sample receptacle 30 can contain the sample of the reservoir fluid 34. The sample of the reservoir fluid 34 can be collected in the sample container 300 by introducing the reservoir fluid 34 into the sample receptacle 30 via the first and/or second openings. The reservoir fluid 34 can be a substance, such as a solid, liquid, gas, or combinations thereof. For example, the reservoir fluid can be a slurry, emulsion, foam, or mist.

The sample container 300 can further comprise a valve 35. The valve 35 can be a one-way valve. As used herein, the term “one-way valve” means a device that allows a fluid to enter a space within an enclosed area in one direction, but does not independently allow the fluid to exit the space in a reverse direction. Of course, a one-way valve may have a release mechanism whereby a person can activate the mechanism thereby causing at least some of the fluid within the sample retaining space to flow out of the enclosed area. However, the one-way valve should be designed such that any fluid that enters the space will not freely flow back out of that space without external intervention. As can be seen in FIG. 1, the valve 35 can be positioned in a first opening of the sample receptacle 30. More than one valve 35 can be located in the sample receptacle 30. According to an embodiment, the step of collecting a sample of the reservoir fluid 34 comprises allowing or causing the reservoir fluid 34 to flow into the sample receptacle 30. The reservoir fluid 34 can be introduced into the sample receptacle 30 via the valve 35 positioned in the first opening of the sample receptacle 30. In this manner, the reservoir fluid can be contained inside the sample receptacle 30 until such time when it is desirable to remove the reservoir fluid from the sample receptacle 30. The sample container 300 can further include a pressurization compartment (not shown). The pressurization compartment can be used to help maintain the reservoir fluid 34 in a single phase.

The sample container 300 can further comprise at least one seal 37. The seal 37 can be positioned adjacent to the sample receptacle 30. The seal 37 can be positioned at either end of the sample receptacle 30. The sample container 300 can also include two or more seals. One seal 37 can be positioned at the first end of the sample receptacle 30 and the other seal (not shown) can be positioned at the second end of the sample receptacle 30. According to an embodiment, the seal is designed such that once in place, a reservoir fluid 34 located within the sample receptacle 30 is not capable of independently exiting the sample receptacle 30. By including two or more seals, any reservoir fluid 34 located within the sample receptacle 30 can be contained.

The seal 37 can be permanently or removably attached to the sample container 300. By way of example, the seal 37 can be removably attached to the sample receptacle 30. In this manner, once a reservoir fluid 34 has been collected and is located inside the sample receptacle 30, the reservoir fluid can be contained within the sample receptacle 30 by attaching the seal 37 to an end of the sample receptacle 30. Moreover, in the event it is desirable to remove the reservoir fluid 34 from the sample receptacle 30, then the seal 37 can be removed. The seal 37 can also include an opening.

The step of collecting a sample of the reservoir fluid can include placing the sample container 300 into a well. The step of collecting can comprise allowing or causing the reservoir fluid 34 to flow into the sample receptacle 30. The methods can further include the step of removing the sample container 300 from the well, wherein the step of removing can be performed after the step of collecting. By way of example, once the sample of the reservoir fluid 34 is collected, the sample container 300 can be returned to the surface. The methods can further include the step of retrieving the sample receptacle 30 from the sample container 300, wherein the step of retrieving is performed after the step of collecting and/or after the step of removing. The methods can further include the step of attaching one or more seals 37 to the ends of the sample receptacle 30, wherein the step of attaching is performed after the step of retrieving. In this manner, the sample of the reservoir fluid 34 can be contained within the sample receptacle 30. The sample of the reservoir fluid 34 can then be stored, analyzed, transferred, or transported to an off-site location.

According to an embodiment, the methods include the step of determining at least one property of the reservoir fluid 34 using an analyzer 20. According to another embodiment, the methods include the step of determining a minimum number of properties of a reservoir fluid 34 using an analyzer 20. According to another embodiment, the step of determining includes determining four or more properties of the reservoir fluid 34. According to yet another embodiment, the number of properties of the reservoir fluid determined is a number such that one or more compositional components of the reservoir fluid are determined. This application can be useful when it is desirable to determine the economic value of the reservoir fluid. In this example, by determining one or more, and preferably all, of the compositional components of the reservoir fluid, one can calculate the economic value of the produced reservoir fluid using the market price of the one or more and preferably all, compositional components and the flow rate of the fluid. It is to be understood that as used herein, the word “property” includes at least one, a minimum number of, and two or more properties of the reservoir fluid without the need to continually refer to every embodiment throughout. Therefore, if the discussion involves “the property,” then the discussion pertains to at least the following embodiments—a single property, a minimum number of properties, and four or more properties of the reservoir fluid.

The minimum number of properties determined can vary depending on the specific regulatory agency's requirement. According to an embodiment, the regulatory agency is an agency that requires reports to be filed for an oil and gas well operation. According to this embodiment, the regulatory agency's requirement is the submission of one or more forms, wherein information about the reservoir fluid must be completed on the form. The information that may need to be completed on the forms includes, but is not limited to, gas volume, oil or condensate volume, water volume, gas to liquid hydrocarbon ratio, gravity of dry gas and liquid hydrocarbon, production rate, and combinations thereof. According to another embodiment, the regulatory agency is an agency that regulates the storage or transportation of a substance. The substance can be produced oil or gas. According to this embodiment, the regulatory agency's requirement is several requirements for a storage or transportation container, wherein the several requirements for the storage or transportation container depend on the composition of the substance. As can be seen, depending on the regulatory agency's requirement or the form to be completed, the minimum number of properties of the reservoir fluid can be in the range from about 4 to about 20. Of course, depending on the regulatory agency's requirement, some information that may need to be obtained can be calculated based on one or more of the determined properties of the reservoir fluid. By way of example, if a state agency that oversees oil or gas operations requires that the absolute open flow needs to be completed on a form that is required to be submitted to that agency, then the absolute open flow can be calculated by determining the gas gravity, oil gravity, gas/liquid ratio, and mixture gravity of the flowing fluid.

The property can be selected from the group consisting of: asphaltenes; saturates; resins; aromatics; solid particulate content; hydrocarbon composition and content; gas composition C₁-C₁₃ and content; carbon dioxide gas; hydrogen sulfide gas; and correlated pressure, volume, or temperature properties including fluid compressibility, gas-to-oil ratio, bubble point, density, a petroleum formation factor, viscosity, a gas component of a gas phase of a petroleum, total stream percentage of water, gas, oil, solid particles, solid types, oil finger printing, reservoir continuity, and oil type; water elements including ion composition and content, anions, cations, salinity, organics, pH, mixing ratios, tracer components, contamination; or other hydrocarbon, gas, solids, or water properties that can be related to spectral characteristics, including the use of regression methods.

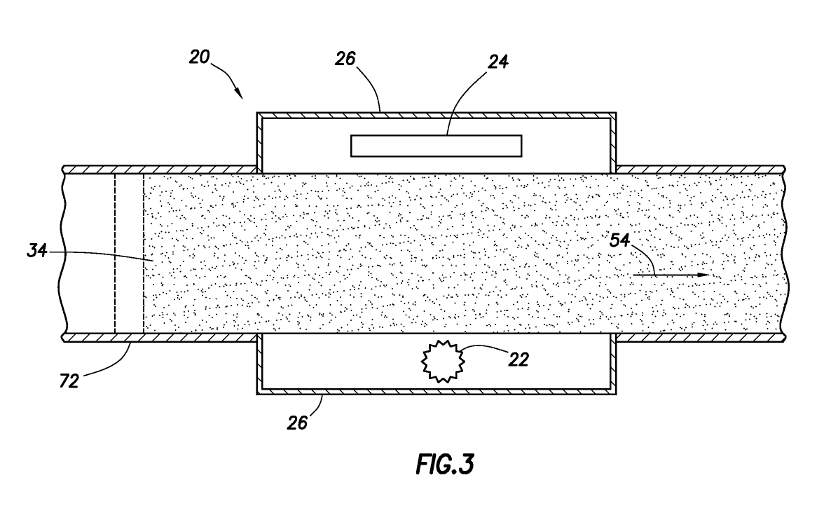

Turning to FIG. 2, the property is determined using an analyzer 20. The analyzer 20 may be an optical analyzer, such as a spectrometer. The analyzer 20 can also be a multivariate optical element (MOE) calculation device. The MOE calculation device is described fully in U.S. Pat. No. 7,697,141 B2, issued on Apr. 13, 2010 to Jones, et al., which is hereby incorporated by reference in its entirety for all purposes. If there is any conflict in the usages of a word or term in this specification and one or more patents or other documents that may be incorporated herein by reference, then the definitions that are consistent with this specification control and should be adopted. The MOE calculation device can be used to determine a two or more properties of the reservoir fluid 34. According to an embodiment, the analyzer 20 includes a source of radiated energy 22 and a detector 24. The source of radiated energy 22 can be a light source. The source of radiated energy 22 and the detector 24 may be selected from all available spectroscopy technologies.

The MOE calculation device can include: a multivariate optical element (MOE), which is an optical regression calculation device; a detector for detecting light reflected from MOE; and a detector for detecting the light transmitted by MOE. The MOE is a unique optical calculation device that comprises multiple layers. For example, a representative optical regression MOE calculation device can comprises a plurality of alternating layers of Nb₂O₅ and SiO₂ (quartz). The layers are deposited on a glass substrate, which may be of the type referred to in this art as BK-7. The number of layers and the thickness of the layers are determined from, and constructed from, the spectral attributes determined from a spectroscopic analysis of a property of the reservoir fluid 34 using a conventional spectroscopic instrument. The combination of layers corresponds to the signature of the property of interest according to the spectral pattern of that property.

The multiple layers can have different refractive indices. By properly selecting the materials of the layers and their spacing, the optical calculation device can be made to selectively pass predetermined fractions of light at different wavelengths. Each wavelength is given a predetermined weighting or loading factor. The thicknesses and spacing of the layers may be determined using a variety of approximation methods from the spectrograph of the property of interest. The approximation methods may include inverse Fourier transform (IFT) of the optical transmission spectrum and structuring the optical calculation device as the physical representation of the IFT. The approximations convert the IFT into a structure based on known materials with constant refractive indices.

The weightings that the MOE layers apply at each wavelength are set to the regression weightings described with respect to a known equation, or data, or spectral signature which can be found for the given property of interest. The optical calculation device MOE performs the dot product of the input light beam into the optical calculation device and a desired loaded regression vector represented by each layer for each wavelength. The MOE output light intensity is directly related to, and is proportional to, the desired reservoir fluid 34 property. The output intensity represents the summation of all of the dot products of the passed wavelengths and corresponding vectors.

By way of example, if the property of interest is resin in a reservoir fluid, and the regression vectors are that of the resin, then the intensity of the light output of the MOE is proportional to the amount of resin in the sample through which the light beam input to the optical calculation device has either passed or has been reflected from or otherwise interacted with. The ensemble of layers corresponds to the signature of resin. These wavelengths are weighted proportionately by the construct of the corresponding optical calculation device layers. The resulting layers together produce an optical calculation device MOE output light intensity from the input beam. The output light intensity represents a summation of all of the wavelengths, dot products, and the loaded vectors of that property, e.g., resin. The output optical calculation device's intensity value is proportional to the amount of resin in the sample being analyzed. In this way an MOE optical calculation device is produced for each property to be determined in the sample.

Such MOE optical calculation devices represent pattern recognition devices which produce characteristic output patterns representing a signature of the spectral elements that define the property of interest. The intensity of the light output is a measure of the proportional amount of the property in the test media being evaluated. Each of the detectors associated with the MOE, transmits its output, an electrical signal, which represents the magnitude of the intensity of the signal that is incident on the detector. Thus, this signal is a summation of all of the intensities of the different wavelengths incident on the detector. The various weighting factors assigned to each layer produce a composite signature waveform for that property.

The reflected light from the MOE, produces a negative of the transmitted signal for no sample or optical absorbance. The reflected signal is subtracted from the transmitted signal by a computer 12. The difference represents the magnitude of the net light intensity output from the MOE and the property in the sample being examined. This subtraction provides correlation that is independent of fluctuations of the intensity of the original light due to power fluctuations, or use of different light bulbs, but of the same type as used in the original apparatus. That is, if the transmitted light intensity varies due to fluctuations, the system could interpret this as a change in property. By subtracting the negative reflections, the result is an absolute value independent of such fluctuations, and thus, provides needed correlation to the desired property being determined. Either the raw detector outputs may be sent to a computer 12, or the signals may be subtracted with an analog circuit and magnified with an operational amplifier converted to voltage and sent to the computer 12 as a proportional signal, for example.

Any other available spectroscopy method can also be used in the determination of the property of the reservoir fluid 34. The spectroscopy can be selected from the group consisting of absorption spectroscopy, fluorescence spectroscopy, X-ray spectroscopy, plasma emission spectroscopy, spark or arc (emission) spectroscopy, visible absorption spectroscopy, ultraviolet (UV) spectroscopy, infrared (IR) spectroscopy (including near-infrared (NIR) spectroscopy, mid-infrared (MIR) spectroscopy, and far-infrared (FIR) spectroscopy), Raman spectroscopy, coherent anti-Stokes Raman spectroscopy (CARS), nuclear magnetic resonance (NMR), photo emission, Mossbauer spectroscopy, acoustic spectroscopy, laser spectroscopy, Fourier transform spectroscopy, and Fourier transform infrared spectroscopy (FTIR), and combinations thereof. The exact spectroscopy method utilized may vary depending on the desired property to be determined. According to an embodiment, the spectroscopy method utilized is selected such that the desired property of the reservoir fluid 34 is detected, and preferably quantified.

The step of determining the property of the reservoir fluid 34 includes contacting the reservoir fluid 34 with radiated energy. The analyzer 20 can include the source of radiated energy 22. The source of radiated energy 22 can be ionizing radiation or non-ionizing radiation. The source of radiated energy 22 can be selected from the group consisting of a tunable source, a broadband source (BBS), a fiber amplified stimulated emission (ASE) source, black body radiation, enhanced black body radiation, a laser, infrared, supercontinuum radiation, frequency combined radiation, fluorescence, phosphorescence, and terahertz radiation. A broadband light source is a source containing the full spectrum of wavelengths, generally ranging from about 720 nm to about 1,620 nm. In an embodiment, the source of radiated energy 22 includes any type of infrared source.

The source of radiated energy 22 (e.g., light) can be emitted in a desired wavelength or range of wavelengths. The desired wavelength or range can be determined based on the desired property of the reservoir fluid to be determined. According to an embodiment, the desired wavelength or range of wavelengths is selected such that the property of the reservoir fluid is determined. For example, if the desired property to be determined is carbon dioxide (CO₂), then the desired wavelength can be selected to be 4,300 nanometers (nm) as CO₂ has an absorption peak at that wavelength. The light emitted can also be in a range that encompasses the desired wavelength. For example, to detect CO₂, the light emitted can be in the mid-infrared range of approximately 2,500 to 25,000 nm. By way of another example, hydrogen sulfide gas (H₂S) can present absorption peaks at 1,900, 2,300, 2,600, 3,800 and 4,100 nm. According to this example the light emitted can include the entire IR spectrum or the NIR and MIR ranges of, 800 to 2,500 nm and 2,500 to 25,000 nm, respectively. By way of another example, CH₄ (C₁ “methane”) and Gas-to-Oil ratio (GOR) can present absorption peaks at approximately 1,700 and 2,300 nm; whereas aromatics can present an absorption peak at approximately 2,450 nm. Accordingly, the light emitted can be in the near IR range.

According to certain embodiments, the methods include the step of determining multiple properties of the reservoir fluid 34. A separate analyzer 20, depicted as 20′ in the Figures, can be used for each property to be determined. While the Figures depict only two analyzers, it is to be understood that three, four, or more analyzers can be used to determine multiple properties of the fluid, wherein each analyzer is capable of determining one or more property of the fluid. According to an embodiment, each analyzer 20 is designed such that the analyzer determines two or more properties of the reservoir fluid 34. According to this embodiment, the wavelength or wavelength range can be selected such that the two or more properties of the reservoir fluid 34 are determined. By way of example, in order to determine if both CO₂ and H₂S are present in the reservoir fluid, the wavelength range can be selected to be the MIR range of approximately 2,500 to 25,000 nm. In this manner, should CO₂ and H₂S both be present in the reservoir fluid, then absorption peaks would indicate such presence. By way of another example, in order to determine if both CH₄ and aromatics are present in the reservoir fluid, the wavelength range can be selected to be the NIR range of approximately 800 to 2,500 nm. In an embodiment the source of radiated energy 22 is directed to the reservoir fluid 34 in order to determine the two or more properties. The source of radiated energy 22 can transmit light rays in a range of from 4,000 to 5,000 nm, which is a range for absorbance of carbon dioxide. Using Beer's Law and assuming a fixed path length, the amount of carbon dioxide in the reservoir fluid 34 is proportional to the absorption of light in this range. The source of radiated energy 22 can also transmit light rays in a range of from 1,900 to 4,200 nm, which is a range for absorbance of hydrogen sulfide. Data collected from these two wavelength ranges may provide information for determining the presence and possibly the amount of carbon dioxide and hydrogen sulfide in the reservoir fluid 34.

The source of radiated energy 22 can be a light source. The light source can be in the IR range. According to an embodiment, the IR light source is a MIR range light source. In an embodiment the MIR range light source is a tunable light source. The tunable light source may be selected from the group of an optical parametric oscillator (OPO) pumped by a pulsed laser, a tunable laser diode, and a broadband source (BBS) with a tunable filter. In an embodiment, the tunable MIR light source is adapted to cause pulses of light to be emitted at or near the absorption peak of the at least one property of the reservoir fluid 34.

The water content of the reservoir fluid 34 can be determined in any manner using optical or non-optical means. According to an embodiment, the water content in the reservoir fluid and the compensation, if any, of the optical response shifts for the determination of the property of the reservoir fluid can be determined.

If the tunable light source is a broadband source, then detection of the property of the reservoir fluid 34 may be improved by applying frequency modulation to the broadband source signal by modulating the drive current or by chopping so that unwanted signals can be avoided in the detector of the analyzer by using phase sensitive detection. The broadband source may be pulsed with or without frequency modulation.

In an embodiment the source of radiated energy 22 can include a laser diode array. In a laser diode array light source system, desired wavelengths are generated by individual laser diodes. The output from the laser diode sources may be controlled in order to provide signals that are arranged together or in a multiplexed fashion. By utilizing a laser diode array light source, time and/or frequency division multiplexing may be accomplished at the spectrometer. A one-shot measurement or an equivalent measurement may be accomplished with the laser diode array. A probe-type or reservoir fluid-type optical cell system may also be utilized.

The step of determining also comprises detecting the interaction between the radiated energy and the reservoir fluid 34. The detection of the interaction can occur via the use of at least one detector 24. According to an embodiment, the analyzer 20 can include at least one detector 24. According to an embodiment, the detector 24 detects the interaction between the radiated energy and the reservoir fluid 34. The radiated energy can be partially or fully absorbed by the reservoir fluid 34, wherein some or none of the radiated energy is then transmitted through the reservoir fluid. According to an embodiment, the detector 24 is capable of detecting the amount of radiated energy that is absorbed and/or transmitted by the reservoir fluid 34. The effectiveness of the detector 24 may be dependent upon temperature conditions. Generally, as temperatures increase, the detector 24 becomes less sensitive. The detector 24 can include a mechanism whereby thermal noise is reduced and sensitivity to emitted radiated energy is increased. The detector 24 can be selected from the group consisting of thermal piles, photo acoustic detectors, thermoelectric detectors, quantum dot detectors, momentum gate detectors, frequency combined detectors, high temperature solid gate detectors, and detectors enhanced by meta materials such as infinite index of refraction, and combinations thereof.

The source of radiated energy 22 can also include a splitter. For example, a light that is emitted can be split into two separate beams in which one beam passes through the reservoir fluid 34 and the other beam passes through a reference reservoir fluid. Both beams are subsequently directed to a splitter before passing to the detector 24. The splitter quickly alternates which of the two beams enters the detector. The two signals are then compared in order to determine the property of the reservoir fluid 34.

The spectroscopy can be performed by a diffraction grating or optical filter, which allows selection of different narrow-band wavelengths from a white light or broadband source. A broadband source can be used in conjunction with Fiber Bragg Grating (FBG). FBG includes a narrow band reflection mirror whose wavelength can be controlled by the FBG fabrication process. The broadband light source can be utilized in a fiber optic system. The fiber optic system can contain a fiber having a plurality of FBGs. Accordingly, the broadband source is effectively converted into a plurality of discrete sources having desired wavelengths.

The spectroscopy can also be Fourier spectroscopy. Fourier spectroscopy, or Fourier transform spectroscopy, is a method of measurement for collecting spectra. In Fourier transform spectroscopy, rather than allowing only one wavelength at a time to pass through the reservoir fluid 34 to the detector 24, this technique lets through a beam containing many different wavelengths of light at once, and measures the total beam intensity. Next, the beam is modified to contain a different combination of wavelengths, giving a second data point. This process is repeated many times. Afterwards, the computer 12 takes all this data and works backwards to infer how much light there is at each wavelength. The analyzer 20 can include one or more mirrors used to select the desired wavelengths to pass through the reservoir fluid 34 to the detector 24. There can be a certain configuration of mirrors that allows some wavelengths to pass through but blocks others (due to wave interference). The beam can be modified for each new data point by moving one of the mirrors; this changes the set of wavelengths that can pass through. The analyzer 20 can internally generate a fixed and variable length path for the optical beam and then recombine these beams, thereby generating optical interference. The resulting signal includes summed interference pattern for all wavelengths not absorbed by the reservoir fluid. As a result, the measurement system is not a one-shot type system, and hence a reservoir fluid-type probe is preferred for use with this type of spectrometer.

The Fourier spectroscopy can utilize an IR light source, also referred to as Fourier transform infrared (FTIR) spectroscopy. In an embodiment, IR light is guided through an interferometer, the IR light then passes through the reservoir fluid 34, and a measured signal is then obtained, called the interferogram. In an embodiment Fourier transform is performed on this signal data, which results in a spectrum identical to that from conventional infrared spectroscopy. The benefits of FTIR include a faster measurement of a single spectrum. The measurement is faster for the FTIR because the information at all wavelengths is detected simultaneously.

As can be seen in FIG. 2, the step of determining the property of the reservoir fluid can further comprise transmitting data from the detector 24 (and a second detector for the MOE calculation device—not shown) to a computer 12. The computer 12 can be used to analyze the data from the detector(s) 24 such that the presence of the property of the reservoir fluid 34 can be determined. The computer 12 can also be used to quantify the amount of the property of the reservoir fluid 34. Either the raw detector data outputs may be sent to the computer 12, or the signals may be subtracted with an analog circuit and magnified with an operational amplifier converted to voltage and sent to the computer 12 as a proportional signal, for example.

As can be seen in FIGS. 2 and 3, the reservoir fluid 34 may be located between the source of radiated energy 22 and the detector 24. As can be seen in FIG. 3, the analyzer can include a housing 26. The housing 26 can contain the source of radiated energy 22 and the detector(s) 24. The housing 26 can be magnetized metal or stainless steel and may have appropriate protective coatings. The housing 26 can be circular, cylindrical, or rectangular. The housing 26 is preferably constructed so that it is readily attachable and detachable from a tube 72. The tube 72 preferably includes a circular or rectangular opening forming a window that is transparent to the radiated energy. In this manner, the radiated energy can penetrate through the opening and come in contact with the reservoir fluid 34 flowing through the tube 72. The interaction between the radiated energy and the reservoir fluid 34 can then be detected via the detector 24 and another opening in the tube 72 adjacent to the detector.

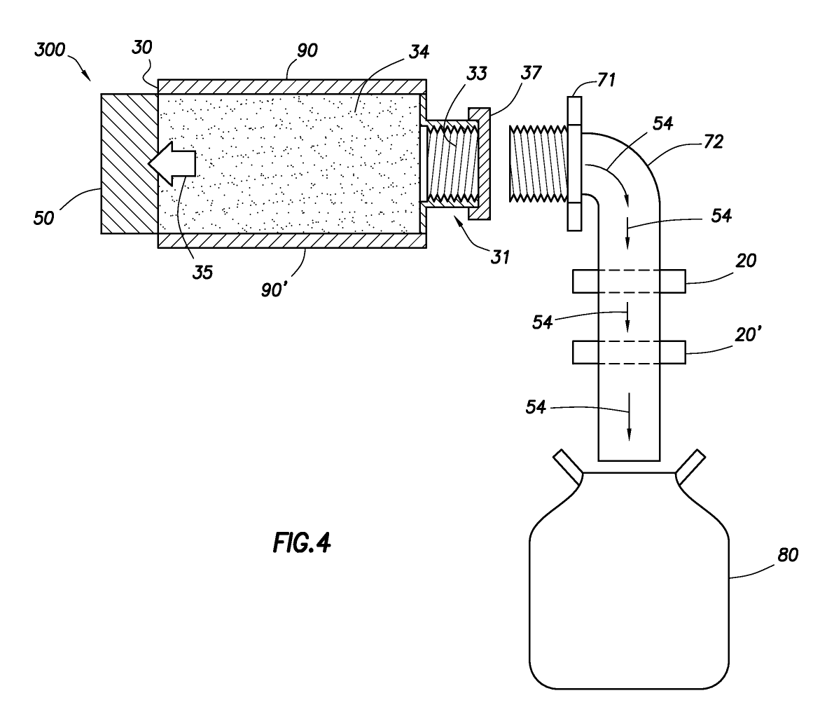

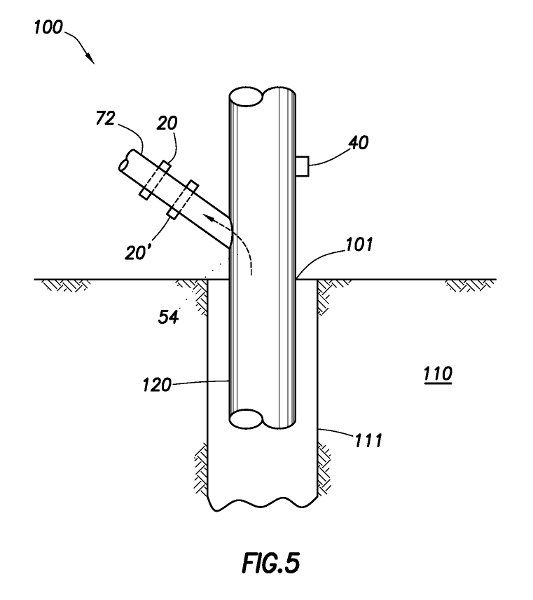

The methods can include the step of collecting a sample of the reservoir fluid 34. As can be seen in FIG. 4, the methods can further include the step of transferring the collected sample of the reservoir fluid 34 from the sample container 300 to a second container 80, wherein the step of transferring is performed after the step of collecting. The second container 80 can be a storage or transportation container. This may be desirable, for example, if the sample container 300 does not meet transportation regulations and the reservoir fluid needs to be transported off-site. The reservoir fluid 34 can be transferred via a tube 72. The tube 72 can be connected to the sample container 300 in a variety of ways, for example, in a manner such that the reservoir fluid 34 is capable of being removed from the sample receptacle 30 and placed into the second container 80. By way of example, the sample container 300 can contain a male end 71 that is capable of connecting to a female end 31 of the tube 72. The ends can be threaded together, for example, via threads 33 on the female end 31. The female end 31 can also include a seal 37. The seal 37 can be removed prior to attaching the tube 72 to the sample container 300. The reservoir fluid 34 can be transferred via a variety of means, for example, via a piston 50. This way, the reservoir fluid 34 can flow from the sample receptacle 30, through the tube 72, and into the second container 80. The reservoir fluid 34 can also be heated via one or more heating elements 90 and 90′. One or more analyzers 20 and 20′ can be positioned adjacent to the tube 72. In this manner, as the reservoir fluid 34 is being transferred from the sample receptacle 30 into the second container 80, the analyzer 20 can determine the property of the reservoir fluid 34. As discussed above, a first analyzer 20 can be designed to determine a first property of the reservoir fluid 34 and a second analyzer 20′ can be designed to determine a second property of the reservoir fluid. Moreover, one analyzer 20 can also be designed to determine two or more properties of the reservoir fluid. There can also be more than two analyzers 20 located adjacent to the tube 72.

According to an embodiment, the step of determining the property of the reservoir fluid 34 is performed when the reservoir fluid is static (i.e., not flowing). According to another embodiment, the step of determining the property of the reservoir fluid 34 is performed during fluid flow of the reservoir fluid. As can be seen in FIG. 1, the step of determining can be performed during the step of collecting a sample of the reservoir fluid 34. As such, the property of the fluid can be determined during fluid flow into the sample receptacle 30. As can be seen in FIG. 4, the step of determining the property of the reservoir fluid 34 can be performed during fluid flow of the reservoir fluid into the second container 80 via the tube 72. The following is one example of use according to an embodiment. The sample container 300 can be introduced into a well. As can be seen in FIG. 1, the analyzer 20 can be located at one end of the sample receptacle 30. One or more reservoir fluids 34 can flow or be caused to flow into one or more sample receptacles 30. As the one or more reservoir fluids 34 flow into each sample receptacle 30, the analyzer 20 can be used to determine one or more properties of the fluid. The analyzer 20 determines the presence and also possibly the amount of the property in real time and reports that information instantaneously as it occurs in the reservoir fluid 34. Each sample container 300 can contain a plurality of sample receptacles 30. Moreover, there can be more than one sample container 300 and there can also be more than one analyzer 20. If there is more than one sample container 300, then a first analyzer 20 can be positioned adjacent to a first sample container 300 and a second analyzer 20′ can be positioned adjacent to a second sample container 300, etc. One analyzer 20 can be designed to determine a first property of the reservoir fluid 34, while another analyzer 20′ can be designed to determine a second property of the reservoir fluid 34.

According to an embodiment, the methods include the step of producing the reservoir fluid. As can be seen in FIG. 5, the step of determining the property of the reservoir fluid 34 can be performed during production of the reservoir fluid. The well system 100 can include a wellbore 111 that penetrates into a subterranean formation 110. The wellbore 111 can include open-hole wellbore portions and also cased-hole wellbore portions. The well system 100 can also include numerous other components not illustrated in the drawings. A tubing string 120, for example a production tubing string, can be positioned within the wellbore 111. The reservoir fluid can be produced and allowed or caused to flow up the tubing string 120 towards the wellhead 101. A tube 72, including one or more analyzers 20, can be connected to the tubing string 120. In this manner, some of the reservoir fluid can flow into the tube 72 in the direction 54. The property of the reservoir fluid can then be determined as the fluid is flowing through the tube 72.

According to an embodiment, the methods include the step of determining the flow rate of the reservoir fluid 34. The flow rate of the reservoir fluid can be determined using a device, such as a flow meter 40. Preferably, the step of determining the flow rate is performed during fluid flow of the reservoir fluid. The step of determining the flow rate of the fluid can be performed during the step of producing, during the step of collecting, or during the step of determining the property of the reservoir fluid. For example, the step of determining the flow rate of the fluid can be performed during fluid flow of the reservoir fluid 34 into the sample receptacle 30, through the tube 72, or through the tubing string 120. Preferably, the step of determining the flow rate is performed at or near the wellhead 101 during fluid flow of the reservoir fluid through the tubing string 120. According to this embodiment, the device for determining the flow rate, such as the flow meter 40, can be connected to the tubing string 120 at or near the wellhead 101.

According to an embodiment, the methods include the step of calculating the economic value of the produced reservoir fluid using the at least one property and the flow rate of the reservoir fluid. The economic value can be calculated in units of a currency per unit of time. The unit of time can be, for example, hours, days, weeks, months, etc. According to an embodiment, the economic value is calculated based on one or more compositional components of the reservoir fluid. Accordingly, the at least one property can be a compositional component of the reservoir fluid (e.g., C₁ content). Preferably, more than one, and more preferably all of the compositional components of the reservoir fluid are determined using the analyzer. The methods can further include the step of determining the percentage of each compositional component in the reservoir fluid using the analyzer. According to this embodiment, the exact compositional components and their respective percentages can be determined using the analyzer. The methods can further include the step of ascertaining the market value of one or more compositional components of the reservoir fluid, wherein the step of ascertaining is performed during or after the step of determining the flow rate of the reservoir fluid. In this manner, as the reservoir fluid is being produced, the market value of the fluid components can be determined at that moment in production. This information can then be used in conjunction with the one or more compositional components, their respective percentages, and their respective market values in order to calculate the total economic value of the reservoir fluid. This information can be useful in determining the marketability of the reservoir fluid, anticipated revenue, and anticipated net profit in a timely and efficient manner.

As discussed above, the property of the reservoir fluid that is determined can be a compositional component of the fluid. The analyzer is used to determine the compositional components of the reservoir fluid. The compositional components that need to be determined, and thus the specific wavelengths and detectors employed in the analyzer can vary depending on the type of fluid being produced. By way of example, if the reservoir fluid being produced is predominately a liquid hydrocarbon (e.g., crude oil), then the compositional components that need to be determined can be SARA (i.e., saturates, asphaltenes, resins, and aromatics), as those compositional components are commonly used to determine the economic value of a reservoir fluid. By contrast, if the reservoir fluid being produced is predominately a gas, then the compositional components that need to be determined can be gas components that have a specific heat value, for example C₁ to C₇ content (i.e., methane, ethane, propane, butane, pentane, and so on). The heat value of a gas component is generally expressed in units of Btu (“British thermal units”). Therefore, in order to determine the economic value of a produced gas—the gas components and relative percentages can be determined using the analyzer; the flow rate of the produced fluid can be determined; the total Btu in the reservoir fluid can be calculated based on the gas components, their percentages, and the flow rate; and then the total currency per unit of time can be calculated using the total Btu being produced per unit of time and the market value of the total Btu.

The methods can further include the step of transporting one or more of the reservoir fluids off-site, wherein the step of transporting can be performed after the step of determining the property of the fluid and/or the flow rate of the fluid.

The information obtained by using the analyzer on reservoir fluids, particularly at a well site, can enable workers to obtain useful and oftentimes, essential information about the properties and flow rate of a reservoir fluid in order to timely and efficiently comply with a regulatory agency's requirement, such as reporting or storage and transportation containers. Moreover, the information obtained at the well site can allow real-time sales analysis or cost benefit analysis to be performed based on the economic value of the produced reservoir fluid.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention. While compositions and methods are described in terms of “comprising,” “containing,” or “including” various components or steps, the compositions and methods also can “consist essentially of” or “consist of” the various components and steps. Whenever a numerical range with a lower limit and an upper limit is disclosed, any number and any included range falling within the range is specifically disclosed. In particular, every range of values (of the form, “from about a to about b,” or, equivalently, “from approximately a to b,”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

What is claimed is:

1. A method of complying with a regulatory agency's requirement comprising:
determining a minimum number of properties of a reservoir fluid using an analyzer, wherein the minimum number of properties is sufficient to comply with the regulatory agency's requirement, and wherein the step of determining comprises:
(A) contacting the reservoir fluid with radiated energy; and
(B) detecting the interaction between the radiated energy and the reservoir fluid.

2. The method according to claim 1, further comprising the step of collecting a sample of the reservoir fluid in a sample container, wherein the step of collecting is performed prior to or during the step of determining.

3. The method according to claim 1, wherein the step of determining includes determining four or more properties of the reservoir fluid.

4. The method according to claim 1, wherein the regulatory agency is an agency that requires reports to be filed for an oil and gas well operation.

5. The method according to claim 4, wherein the regulatory agency's requirement is the submission of one or more forms, wherein information about the reservoir fluid must be completed on the form.

6. The method according to claim 1, wherein the regulatory agency is an agency that regulates the storage or transportation of a substance.

7. The method according to claim 6, wherein the substance is the produced reservoir fluid.

8. The method according to claim 6, wherein the regulatory agency's requirement is several requirements for a storage or transportation container, wherein the several requirements for the storage or transportation container depend on the composition of the substance.

9. The method according to claim 1, wherein the minimum number of properties of the reservoir fluid is in the range from about 4 to about 20.

10. The method according to claim 1, wherein the minimum number of properties are selected from the group consisting of: asphaltenes; saturates; resins; aromatics; solid particulate content; hydrocarbon composition and content; gas composition C₁-C₁₃ and content; carbon dioxide gas; hydrogen sulfide gas; and correlated pressure, volume, or temperature properties including fluid compressibility, gas-to-oil ratio, bubble point, density, a petroleum formation factor, viscosity, a gas component of a gas phase of a petroleum, total stream percentage of water, gas, oil, solid particles, solid types, oil finger printing, reservoir continuity, and oil type; water elements including ion composition and content, anions, cations, salinity, organics, pH, mixing ratios, tracer components, contamination; or other hydrocarbon, gas, solids, or water properties that can be related to spectral characteristics, including the use of regression methods.

11. The method according to claim 1, wherein the analyzer is a spectrometer.

12. The method according to claim 1, wherein the analyzer is a multivariate optical element calculation device.

13. The method according to claim 1, wherein the step of determining the minimum number of properties of the reservoir fluid is performed when the reservoir fluid is flowing.

14. A method of determining the economic value of a produced reservoir fluid comprising:
(A) producing the reservoir fluid;
(B) determining at least one property of the reservoir fluid using an analyzer, wherein the step of determining comprises:
(i) contacting the reservoir fluid with radiated energy; and
(ii) detecting the interaction between the radiated energy and the reservoir fluid;
(C) determining the flow rate of the reservoir fluid, wherein the step of determining the flow rate is performed during the step of producing; and
(D) calculating the economic value of the produced reservoir fluid using the at least one property and the flow rate of the reservoir fluid.

15. The method according to claim 14, wherein the step of determining includes determining four or more properties of the reservoir fluid.

16. The method according to claim 14, wherein the step of determining the at least one property of the reservoir fluid is performed during the step of producing the reservoir fluid.

17. The method according to claim 14, wherein the at least one property of the reservoir fluid is selected from the group consisting of: asphaltenes; saturates; resins; aromatics; solid particulate content; hydrocarbon composition and content; gas composition C₁-C₁₃ and content; carbon dioxide gas; hydrogen sulfide gas; and correlated pressure, volume, or temperature properties including fluid compressibility, gas-to-oil ratio, bubble point, density, a petroleum formation factor, viscosity, a gas component of a gas phase of a petroleum, total stream percentage of water, gas, oil, solid particles, solid types, oil finger printing, reservoir continuity, and oil type; water elements including ion composition and content, anions, cations, salinity, organics, pH, mixing ratios, tracer components, contamination; or other hydrocarbon, gas, solids, or water properties that can be related to spectral characteristics, including the use of regression methods.

18. The method according to claim 17, wherein the at least one property of the reservoir fluid is a compositional component of the reservoir fluid.

19. The method according to claim 18, wherein all of the compositional components of the reservoir fluid are determined using the analyzer.

20. The method according to claim 18, further comprising the step of ascertaining the market value of one or more compositional components of the reservoir fluid, wherein the step of ascertaining is performed during or after the step of determining the flow rate of the reservoir fluid.

21. The method according to claim 14, wherein the step of determining the flow rate of the fluid is performed during the step of producing or during the step of determining the at least one property of the reservoir fluid.

22. The method according to claim 14, wherein the economic value is calculated in units of a currency per unit of time.
